(19) United States
(12) Patent Application Publication
(10) Pub. No.: US 2008/0193130 A1
(43) Pub. Date: Aug. 14, 2008

(54) Pon System With a Remote Upstream Repeater

(75) Inventors: Chang-Joon Chae, Victoria (AU); Rodney Stuart Tucker, Victoria (AU)

Correspondence Address: SNELL & WILMER LLP (OC), 600 ANTON BOULEVARD, SUITE 1400, COSTA MESA, CA, 92626, US

(73) Assignee: National ICT Australia Limited, Eveleigh, NSW (AU)

(21) Appl. No.: 11/575,463

(22) PCT Filed: Sep. 16, 2005
(86) PCT No.: PCT/AU2005/001424

§ 371 Date: Dec. 12, 2007

(30) Foreign Application Priority Data
Sep. 17, 2004 (AU) 2004905387

(51) Int. Cl. H04J 14/00

(52) U.S. Cl. 398/67

(57) ABSTRACT

A signal coupler (20) for a passive optical network (PON) system is disclosed. The coupler (20) includes a first port for two-way feeder side communication with a PON terminal (12), a star coupler (29), other ports (23) for two-way distribution side communication with each of plural remote optical network units (ONUs) (30), and a repeater (28) installed on the upstream signal path from the ONUs (30) to the PON terminal (12). Upstream signals from ONUs (30) are received by the repeater (28) without passing through the star coupler (29) by using a coarse wavelength division multiplexer (50) on each distribution fibre and taking out the upstream light before arrival at the star coupler (29) and redirecting it to a receiver array and multiplexer (52). The repeater (28) regenerates each upstream signal and changes its wavelength.

### CROSS-REFERENCE TO RELATED APPLICATIONS

The present application claims priority from Australian Provisional Patent Application No 2004905387 filed on 17 Sep. 2004, the content of which is incorporated herein by reference.

### TECHNICAL FIELD

This invention concerns a coupler unit for a passive optical network (PON) system, and in particular a coupler unit to simplify the required functionality of customer optical network units (ONUs) associated with the coupler unit. In a further aspect the invention concerns the PON system containing an OLT, the coupler unit and the ONUs.

### BACKGROUND ART

PONs first appeared in the late 1980's and promised to provide cost-effective fibre to the home (FTTH). A PON system is typically envisaged with an optical line terminal (OLT) at a central hub, a single feeder fibre extending long distances from the central hub to a coupler unit, and many remote customer optical network units (ONUs) clustered around each coupler unit. Each coupler unit typically contains a 1×N star coupler to couple the single feeder fibre from the OLT to N fibres each connected to respective ONUs. However, large scale PON deployment has to date been frustrated by the high-cost of the customer's optical network unit (ONU) which is required at each customer's premises and contains a costly laser transmitter.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DISCLOSURE OF THE INVENTION

According to a first aspect the present invention provides a signal coupler for a PON system having a first port for two way feeder side communication with a PON terminal, a star coupler, and other ports for two-way distribution side communication with each of plural respective remote ONUs. The signal coupler also includes a repeater installed on the upstream signal path from the ONUs to the PON terminal. Upstream signals from ONUs are received by the repeater without passing through the star coupler, and the repeater operates to regenerate each upstream signal and change its wavelength.

According to a second aspect the present invention provides a method of coupling signals in a PON system, the method comprising:

coupling two way communications between.a PON terminal, and a plurality of ONUs;

receiving upstream signals from the ONUs which have not passed through a coupler; and

regenerating and changing a wavelength of the upstream signals.

Embodiments of the first and second aspects of the invention eliminate the need for each ONU transmitter to output sufficient power for upstream signals to negotiate a star coupler and up to tens of kilometres of feeder fibre. For example, upstream signals passing through a star coupler may encounter 15 dB loss, while 20 km of feeder fibre may cause a further 10 dB loss. In the present invention, both star coupler losses and feeder fibre losses are eliminated from the required power budget of upstream ONU transmitters, as the repeater regenerates upstream signals before the upstream signals pass through either the star coupler or the feeder fibre. Consequently, ONU transmitter power requirements can be substantially reduced, for example by 25 dB in some embodiments. Embodiments of the first and second aspects of the present invention thus enable use of a low cost light source at each ONU for upstream transmission.

According to a third aspect the present invention provides a PON system comprising an OLT, a feeder fibre extending from the OLT to a signal coupler in accordance with the first aspect of the invention, and a plurality of ONUs optically connected to the signal coupler.

According to a fourth aspect the present invention provides a signal coupler for a PON system having a first port for two way feeder side communication with a PON terminal, a star coupler, and other ports for two-way distribution side communication with each of plural respective remote ONUs. The signal coupler also includes a repeater installed on the upstream signal path from the ONUs to the PON terminal. Upstream signals from ONUs are received by the repeater, and the repeater operates to regenerate each upstream signal and change its wavelength. The repeater is operable to inject regenerated upstream signals back into the star coupler in a downstream direction for distribution to the ONUs.

According to a fifth aspect the present invention provides a method of coupling signals in a PON system, the method comprising:

coupling two way communications between a PON terminal, and a plurality of ONUs;

receiving upstream signals from the ONUs;

regenerating and changing a wavelength of the upstream signals to produce regenerated upstream signals; and

injecting the regenerated upstream signals in a downstream direction for distribution to the plurality of ONUs.

Embodiments of the fourth and fifth aspects may enable implementation of a LAN, for example a CSMA/CD EPON LAN. Each ONU may for example employ a CSMA/CD unit of the type disclosed in International Patent Publication No. WO 03/015316, the content of which is incorporated herein by reference. By regenerating LAN signals received in an upstream direction prior to re-injection of the regenerated signals in a downstream direction, embodiments of the fourth and fifth aspects of the invention further allow for use of low power ONU transmitters in implementing a LAN. The upstream signals may be received by the repeater without having passed through a star coupler of the signal coupler, or alternatively may be received by the repeater after having passed through a star coupler of the signal coupler.

According to a sixth aspect the present invention provides a PON system comprising an OLT, a feeder fibre extending from the OLT to a signal coupler in accordance with the fourth aspect of the invention, and a plurality of ONUs optically connected to the signal coupler.

The use of a repeater provides opportunity for much lower-cost implementation of the customer's optical network unit (ONU) using low power and low cost optical transmitters, such as 0.8/1.3/1.55 μm VCSEL-based transmitters. The combined savings at the customer units may greatly outweigh the cost of the repeater at the coupler unit. As a result fibre to the home or desk deployment may become economically feasible for the present and future Internet-oriented access networks and enterprise networking. The invention is compatible with conventional PON systems described in the preceding, and uses the conventional PON fibre plant for both downstream and upstream transmissions.

The coupler unit may use separate downstream and upstream wavelengths on the feeder side and an optical multiplexer to separate and combine those wavelengths.

The downstream signal need not be regenerated at the coupler unit and may be passively passed through to the ONUs. As a result the downstream channel can be upgraded without any change in the repeater. Furthermore the coupler can easily be returned back to conventional PON operation by simply replacing the repeater with a conventional coupler unit.

An optical isolator may be provided at the coupler unit in the downstream signal path, downstream of the multiplexer, on the feeder side to prevent upstream traffic by-passing the repeater.

A further optical multiplexer and plural star couplers may be provided at the coupler unit for feeder side communication over plural downstream and upstream wavelength channels with another multiplexer at the PON terminal. The different wavelengths may be interleaved.

Additional multiplexers may be located at the coupler unit for splitting upstream communications on the distribution side, and a receiver array and multiplexer (RAM) may be used for receiving the upstream communications and passing them to the repeater.

An additional output may be provided on the repeater to enable additional signal processing functionality at the coupler unit; such as optical CSMA/CD, optical polling, optical LAN, multiplexing, diagnostics, signal processing and MAC protocols.

Multi-mode fibres or polymer fibres can be used in the distribution part of the PON system making the system highly compatible with the existing fibre infrastructure in a building; for fibre to the home or desktop as well as other optical LAN applications. Upstream access speed can be cost-effectively upgraded as demand grows.

Upstream transmission for the feeder part of the PON system is possible using a low specification upstream laser/LED transmitter at the coupler unit since there are low losses in the upstream path.

The invention may be used to replace asymmetric digital subscriber line (ADSL) or very-high speed digital subscriber line (VDSL) based fibre to the curb (FTTC) systems. The current copper solutions are limited in length and data rate (up to 1.5 km at 15 Mb/s, or up to 300 m at 52 Mb/s). The invention can offer higher bandwidth and longer distance at much lower cost and, considering the typical asymmetric access traffic pattern and future upgrade to 1.25 Gb/s, is more efficient than any copper solutions. The invention can be also applied to enterprise networks by replacing a current active hub by a star coupler and repeater for fibre to the desktop (FTTD).

### BRIEF DESCRIPTION OF THE DRAWINGS

Examples of the invention will now be described with reference to the accompanying drawings, in which:

FIG. 1 is a schematic diagram of a PON system.

FIG. 2 is a schematic diagram of a variant PON system.

FIG. 3 is a schematic diagram of an alternative PON system.

FIG. 4 is a schematic diagram of an associated application for the PON system.

### BEST MODES OF THE INVENTION

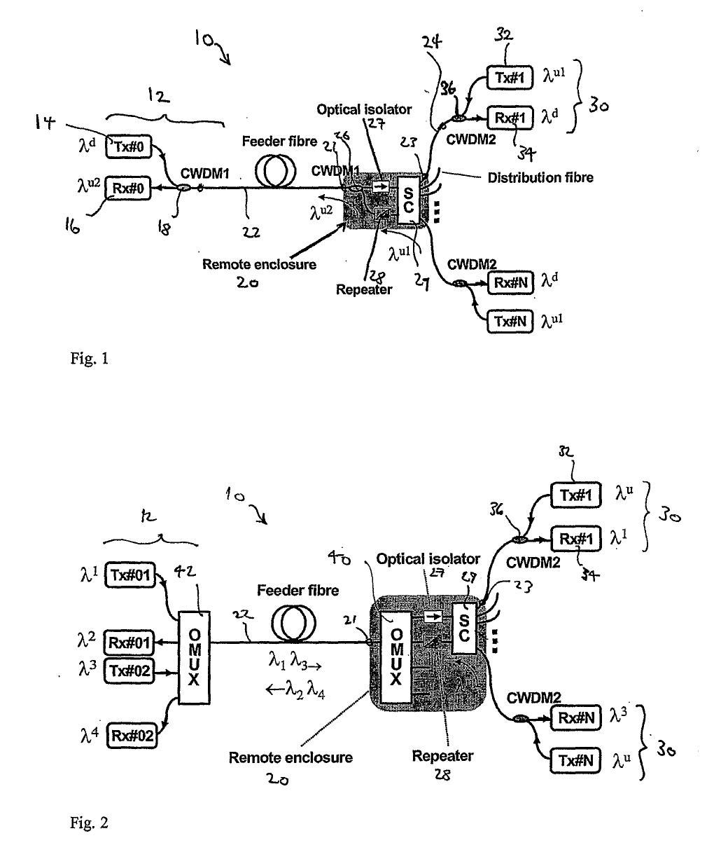

Referring first to FIG. 1, a passive optical network (PON) 10 consists of an optical line terminal 12 having a single downstream transmitter 14, a single upstream receiver 16 and a coarse wavelength division multiplexer 18.

A coupler unit 20 is located remote from the line terminal 12, and a feeder side port 21 is connected to terminal 12 by a single feeder fibre 22. A number (N) of optical network units 30 are clustered around the coupler unit 20, and a distribution side port 23 is connected to each network unit 30 by respective distribution fibres 24. The distribution side fibres 24 are typically no more than a few kilometres in length. The coupler unit enclosure 20 contains a coarse wavelength division multiplexer 26, an optical isolator 27, an optical repeater 28, a single 2×N optical star coupler 29, and a power regulation circuit (not shown) for the repeater. Because of the need for power, the enclosure will generally be installed near or inside a customer building for access to commercial power lines with a battery back-up.

Each network unit 30 has a single low power upstream transmitter 32, a single downstream receiver 34 and a coarse wavelength division multiplexer 36. The upstream transmitter 32 is a GaAs (0.8 μm wavelength) based vertical cavity surface emitting laser (VCSEL) which is a mass-produced item having much lower-cost than the InP (1.3˜1.5 μm wavelength) based Fabry-Perot (FP) or distributed feedback (DFB) laser diodes. A suitable alternative might be the InP based VCSEL which are expected to appear in the future market, but they are not likely to better GaAs based VCSEL's in terms of cost and reliability. GaAs and InP based light emitting diodes (LED's) may also be suitable, and these are also mass-produced and readily available in the market at low prices.

Technologies such as GaAs and InP based VCSEL's or GaAs and InP based LED's enable low-cost fabrication of reliable ONU transmitters, reducing per-customer cost of FTTH.

Two different wavelengths, λ^{d} and λ^{u}, are assigned for downstream and upstream transmissions respectively. Different upstream wavelengths λ^{u2} and λ^{u1} are used respectively in the feeder and distribution parts of the PON 10.

The coarse wavelength division multiplexing devices 18 and 36 are used to combine and separate these wavelengths at the terminal 10 and customer units 30. At the terminal 10, multiplexer 18 separates λ^{d} and λ^{u2}, and at the network units 30 multiplexer 36 separates λ^{d} and λ^{u1}.

The optical repeater 28 installed at the location of the coupler unit 20 simply converts the incoming upstream λ^{u1} optical signals to electrical signals, and then converts the electrical signals back to optical signals at a different wavelength λ^{u2}. The repeater is like a conventional transponder, already in use, with its transmitting and receiving ends tied together internally. The repeater 28 operates to clean the signals and as a result permits the use of low power and low cost transmitters at the customer's network units.

A single InP based FP laser, DFB laser or VCSEL is used in the implementation of the repeater 28 to drive the upstream signal into the feeder part of the PON. The optical power requirement is much less than a conventional network unit transmitter because the feeder side optical link does not include a lossy star coupler.

Referring now to FIG. 2, the cost of a large PON system can be further reduced by introducing more multiplexing technology on the feeder side. An optical multiplexer (OMUX) has channel spacing, for example at 20 nm, wide enough to continue operating during temperature variations of the outside plant (enclosure). A four channel OMUX 40 is installed in the coupler unit 20 together with two 1×N couplers 29, and another OMUX 42 is installed at the terminal 12. The OMUX's multiplex and demultiplex at the same time and provide four channels λ₁, λ₂, λ₃ and λ₄ on the feeder side; a downstream and an upstream channel for each of the two star couplers. There is still only a single feeder fibre 22.

On the distribution side each star coupler uses a different downstream wavelength; for instance coupler 29 is shown to use λ¹ and λ³ to communicate to two different network units 30. But all the network units connected to a particular star coupler 29 use λ^{u} for upstream communication. At the star coupler 29 the repeater 28 in the upstream path changes the wavelengths of the upstream transmissions from λ^{u} on the distribution side to μ₂ on the feeder side.

The upstream wavelengths from the different coupler units λ₂ and λ₄ can be interleaved to minimize the effect of optical reflection, Rayleigh back scattering, fibre nonlinearity, and so on. The wavelengths may be in the same wavelength band or different wavelength band. Furthermore, the wavelengths can be arranged such that downstream and upstream wavelengths to and from a same star coupler and repeater lie side by side. The feeder links can be also implemented using a different type of networks such as tree, ring, bus, etc. depending on the application.

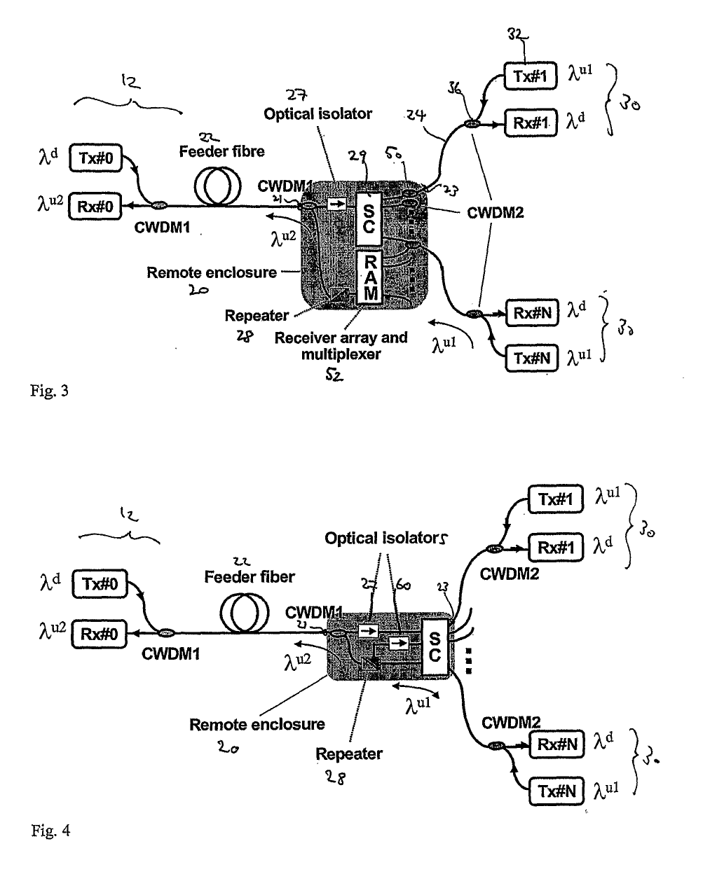

Referring now to FIG. 3, an alternative implementation for extremely low-power network unit transmitters 32 uses an additional coarse wavelength division multiplexer 50 on each distribution fibre near the coupler unit 20 to take out the upstream light, of wavelength λ^{u1}, before arrival at the star coupler 29. The extracted lights are detected by an array photo-detector or N individual detectors at a receiver array and multiplexer (RAM) 52. The upstream lights are subsequently combined together to a single channel upstream channel at wavelength λ^{u2}. The multiplexing can be done in the electrical domain just after optical-to-electrical conversion, or by digital communication processing at bit or packet level. At this stage, packet power levels can be automatically adjusted to the same value to reduce dynamic range seen by a receiver at the optical line terminal.

Referring finally to FIG. 4, signal processing may take place at the coupler unit 20 in the optical or electronic domain in order to implement other functionalities. To achieve this the repeater 28 has two transmitters, one for upstream transmission and the other for other applications such as optical CSMA/CD and local area networking. The repeater may contain an electronic signal processing module to perform other functions.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A signal coupler for a PON system, the signal coupler comprising:
a first port for two way feeder side communication with a PON terminal;
a star coupler;
other ports for two-way distribution side communication with each of plural respective remote ONUs; and
a repeater installed on the upstream signal path from the ONUs to the PON terminal, such that upstream signals from ONUs are received by the repeater without passing through the star coupler, wherein the repeater is operable to regenerate each upstream signal and change its wavelength.

2. A signal coupler according to claim 1 wherein separate downstream and upstream wavelengths are used on the feeder side, and an optical multiplexer is provided to separate and combine the wavelengths.

3. A signal coupler according to claim 2, wherein an optical isolator is provided at the coupler unit in the downstream signal path, downstream of the multiplexer, on the feeder side to prevent upstream traffic by-passing the repeater.

4. A signal coupler according to claim 1, wherein the downstream signal is not regenerated at the coupler unit and is passively passed to the ONUs.

5. A signal coupler according to claim 1 further comprising at least a second star coupler for feeder side communication over plural downstream and upstream wavelength channels with the PON terminal.

6. A signal coupler according to claim 5, wherein the different wavelengths are interleaved.

7. A signal coupler according to claim 1, comprising multiplexers for splitting upstream communications on the distribution side, and comprising a receiver array and multiplexer (RAM) for receiving the upstream communications and passing them to the repeater.

8. A signal coupler according to claim 1, wherein the repeater further comprises at least a second output to enable additional signal processing functionality at the signal coupler.

9. A signal coupler according claim 1, wherein multi-mode fibres or polymer fibres are used on the distribution side.

10. A PON system comprising an OLT, a feeder fibre extending from the OLT to the first port of a signal coupler in accordance with claim 1, and a plurality of ONUs optically connected to the distribution side of the signal coupler.

11. A PON system according to claim 10 wherein each ONU comprises a low specification upstream laser/LED transmitter.

12. A method of coupling signals in a PON system, the method comprising:
coupling two way communications between a PON terminal, and a plurality of ONUs;
receiving upstream signals from the ONUs which have not passed through a coupler; and
regenerating and changing a wavelength of the upstream signals;
wherein the two way feeder side communications with the PON terminal are via a first port.

13. A signal coupler for a PON system, the signal coupler comprising:
a first port for two way feeder side communication with a PON terminal;
a star coupler;
other ports for two-way distribution side communication with each of plural respective remote ONUs;
a repeater installed on the upstream signal path from the ONUs to the PON terminal, for receiving upstream signals from ONUs and for regenerating each upstream signal and changing its wavelength, and wherein the repeater is operable to inject regenerated upstream signals into the star coupler in a downstream direction for distribution to the ONUs.

14. The signal coupler of claim 13 wherein the repeater is further operable to transmit regenerated upstream signals upstream to the feeder side.

15. A signal coupler according to claim 13 wherein separate downstream and upstream wavelengths are used on the feeder side, and an optical multiplexer is provided to separate and combine the wavelengths.

16. A signal coupler according to claim 15, wherein an optical isolator is provided at the coupler unit in the downstream signal path, downstream of the multiplexer, on the feeder side to prevent upstream traffic by-passing the repeater.

17. A signal coupler according to claim 13, wherein the downstream signal is not regenerated at the coupler unit and is passively passed to the ONUs.

18. A signal coupler according to claim 12 further comprising at least a second star coupler for feeder side communication over plural downstream and upstream wavelength channels with the PON terminal.

19. A signal coupler according to claim 18, wherein the different wavelengths are interleaved.

20. A signal coupler according to claim 13, comprising multiplexers for splitting upstream communications on the distribution side, and comprising a receiver array and multiplexer (RAM) for receiving the upstream communications and passing them to the repeater.

21. A signal coupler according to claim 13, wherein the repeater further comprises at least a second output to enable additional signal processing functionality at the signal coupler.

22. A signal coupler according to claim 13, wherein multi-mode fibres or polymer fibres are used on the distribution side.

23. A PON system comprising an OLT, a feeder fibre extending from the OLT to the first port of the signal coupler of claim 13, and a plurality of ONUs optically connected to the signal coupler.

24. A PON system according to claim 23 wherein each ONU comprises a low specification upstream laser/LED transmitter.

25. A PON system according to claim 23 wherein the ONUs function to form a LAN.

26. A PON system according to claim 25, wherein the ONUs each comprise a CSMA/CD unit to form an EPON LAN.

27. A method of coupling signals in a PON system, the method comprising:
coupling two way communications between a PON terminal, and a plurality of ONUs;
receiving upstream signals from the ONUs;
regenerating and changing a wavelength of the upstream signals to produce regenerated upstream signals; and
injecting the regenerated upstream signals in a downstream direction for distribution to the plurality of ONUs.

28. A signal coupler for a PON system, the signal coupler comprising:
a first port for two way feeder side communication with a PON terminal;
other ports for two-way distribution side communication over multi-mode fibres with each of plural respective remote ONUs sharing a single upstream wavelength; and
a repeater installed on the upstream signal path from the ONUs to the PON terminal, the repeater operable to regenerate upstream signals at the shared upstream wavelength.

29. A signal coupler according to claim 28, wherein separate downstream and upstream wavelengths are used on the feeder side, and an optical multiplexer is provided to separate and combine them.

30. A signal coupler according to claim 28, wherein the downstream signal is not regenerated at the coupler unit but is sent through to the customers' network units.

31. A signal coupler according to claim 28, wherein an optical isolator is provided at the coupler unit in the downstream signal path, downstream of the multiplexer, on the feeder side to prevent upstream traffic by-passing the repeater.

32. A signal coupler according to claim 29, wherein a further optical multiplexer and plural star couplers are provided at the coupler unit for feeder side communication over plural downstream and upstream wavelength channels with another multiplexer at the PON terminal.

33. A signal coupler according to claim 32, wherein the different wavelengths are interleaved.

34. A signal coupler according to claim 28, wherein additional multiplexers are located at the coupler unit for splitting upstream communications on the distribution side, and a receiver array and multiplexer (RAM) is used for receiving the upstream communications and passing them to the repeater.

35. A signal coupler according to claim 28, wherein an additional output is provided on the repeater to enable additional signal processing functionality at the coupler unit.

36. A signal coupler according to claim 28, wherein a low specification upstream laser/LED transmitter is provided at the coupler unit.

37. The signal coupler of claim 28 wherein the repeater regenerates signals at the upstream wavelength without changing wavelength.
